(19) United States
(12) Patent Application Publication
(10) Pub. No.: US 2026/0137241 A1
(43) Pub. Date: May 21, 2026

(54) REGULATION OF WISKING OF A FOOD SUBSTANCE

(71) Applicant: SOCIETE DES PRODUITS NESTLE S.A., Vevey (CH)

(72) Inventors: DA MI BYUN, Lausanne (CH); ERIC GRANGER, Pully (CH)

(21) Appl. No.: 19/446,059

(22) Filed: Jan. 12, 2026

Related U.S. Application Data
(63) Continuation of application No. 17/597,540.

(30) Foreign Application Priority Data
Jul. 11, 2019 (EP) 19185813.3

(51) Int. Cl. A47J 43/08; A47J 43/046

(52) U.S. Cl. CPC A47J 43/085; A47J 43/046; A47J 43/0465

(57) ABSTRACT

A machine has a tank having a cavity for containing and processing a batch of liquid food substance; a stirring tool in the cavity having a stirring surface for imparting a mechanical effect on said food substance in the cavity to froth the food substance; an actuator configured to rotate the stirring tool in the cavity; and a control unit configured to control the actuator so that the rotational speed of the stirring tool is changeable. The control unit has a mode in which the actuator is controlled by the control unit so that: during a first phase of processing the batch, the stirring tool is rotated below a low frothing rotational speed; and thereafter during a second phase of processing said batch, the rotational speed of the stirring tool is increased from the low frothing rotational speed to above a high frothing rotational speed; and thereafter during a third phase of processing said batch, the stirring tool is rotated above the high frothing rotational speed.

### CROSS REFERENCE TO RELATED APPLICATIONS

The present application is a continuation of U.S. patent application Ser. No. 17/597,540, filed on Jan. 11, 2022, which is a National Stage of International Application No. PCT/EP2020/069482, filed on Jul. 10, 2020. which claims priority to European Patent Application No. 19185813.3, filed on Jul. 11, 2019, the entire contents of which are incorporated herein by reference.

### FIELD OF THE INVENTION

The field of the invention pertains to machines for processing a food substance, such as milk or a milk-containing substance, having a food processing receptacle that is seizable single-handed. For instance, the machine is provided with an impeller and/or a thermal management arrangement.

### BACKGROUND

Speciality beverages in which at least a portion is made up of frothed or heated milk are becoming more and more popular. The best-known beverage of this type is a coffee of the cappuccino type. It comprises a liquid portion consisting of coffee topped by a layer of frothed milk which, because of its very much lower density, floats atop the surface of the liquid. In general, preparing one takes time, manipulation operations and cleaning.

Milk-based froth can be prepared in a mechanical stirring appliance. Regular cleaning of the tank of the appliance needs to be envisaged in order to remove any solid food residue. In addition, heating the milk has a tendency to increase the extent to which cooked or burnt proteins are deposited on and adhere to the surfaces.

U.S. Pat. No. 6,318,247 relates to an appliance for preparing hot beverages or food with stirring such as hot chocolate, for example. Other devices for stirring food products are described in patent documents WO 2004/043213 or DE 196 24 648. Stirring systems with a magnetic engagement type are described in documents U.S. Pat. No. 2,932,493, DE 1 131 372, U.S. Pat. Nos. 4,537,332 and 6,712,497. DE 89 15 094 relates to a refrigerated pot for dispensing a milk-based beverage. U.S. Pat. No. 3,356,349 discloses a stirring device that has a heated tank, magnetic drive means positioned under the tank for driving a hub located in the middle of the tank.

Further examples of beverage processing appliances using stirring systems, in particular magnetically driven stirring systems, are disclosed in WO 2016/202814, WO 2016/202815, WO 2016/202816, WO 2016/202817, WO 2018/108804 and WO 2018/108807.

An improved appliance for preparing froth from a milk-based liquid or milk has been proposed in WO 2006/050900, WO 2008/142154, WO 2010/023313, WO 2011/039222, WO 2011/039224 and WO 2017/216133. The device has: an inner tank for receiving the liquid that is to be frothed, in which a rotatable stirrer is positioned; an outer stand holding the tank; drive and control means which are in a cavity located between the inner tank and the outer stand, and which communicate with a switch and electrical connections located on the outer surface of the stand; and disturbance means to optimise circulation of the milk during frothing.

Heat can be provided into the processing tank by using an induction system, e.g. as disclosed in WO 2019/101765.

It has been proposed, as described in WO 2009/074555 and WO 2011/144647, to provide a coffee machine with this type of milk conditioning tank. In WO 2009/074555 the upright surface of the processing tank is profiled to facilitate hand gripping.

An architecture to favour the evacuation of unwanted heat generated by the operation of electric components of the milk frothing appliance has been disclosed in WO 2016/202818. As disclosed in WO 2018/108808 and WO 2019/101764, such appliance can also be fitted with one or more fan coolers.

WO 2017/216133, WO 2019/101765 and PCT/EP 19/057841 disclose a beverage processing tank. The beverage can be heated in the tank. To dispense the processed beverage, the tank is fitted with a handle that has a connection member projecting from the tank and a generally upright elongated gripping part extending above and below the connection member.

WO 2017/098037 discloses a beverage processing tank with a heating wall and an off-centred impeller, the speed of which varies during processing to shift (low beverage speed) hot spots of the heating wall so as to avoid localised overheating of beverage at such hot spots.

There is still a need to improve the processing of beverage in such appliances.

### SUMMARY

It is a preferred object of the present invention to provide a machine for optimizing the frothing of a food substance, such as milk or a milk-based substance, to provide high quality froth, for example a machine able to froth larger amounts of food substance and/or to froth food substance at ambient or lower temperature.

The invention thus relates to a machine for processing a liquid food substance, such as milk or a milk-based substance. The liquid food substance can be aqueous, e.g. containing coffee and/or chocolate and/or cacao.

The machine may be a standalone machine, e.g. directly pluggable to the mains via an electric cord, or may be integrated in a food processor arranged to process other food items or to carry out different food conditioning processes, the food processor itself being generally pluggable to the mains via an electric cord whereas the machine is a sub-part of the food processor. Such a food processor may be a beverage maker, such as a coffee maker, e.g. a beverage maker configured to prepare a beverage (such as coffee) from an ingredient capsule.

The machine of the invention may advantageously be configured to froth and/or heat and/or cool milk and optionally be associated, as a standalone machine or as an integrated machine, into a coffee maker. Standalone machines and integrated associations of milk frothing machines and coffee makers are for example disclosed in WO 2006/050900, WO 2008/142154, WO 2009/074555, WO 2010/023312 and WO 2010/023313.

Hence, the machine can be a milk frother which operates by incorporating finely divided gas bubbles, e.g. air bubbles, into milk. When the machine is configured for incorporating gas bubbles into milk, it may include an operating mode without incorporation of gas bubbles.

The machine of the invention is configured for processing a liquid food substance, such as milk or a milk-based substance.

Therefore, the machine includes a tank having a cavity for containing and processing a batch of liquid food substance, such as milk or a milk-based substance.

The cavity may have a volume that is greater than 200 ml, for instance in the range of 250 to 1250, such as in the range 300 to 1000 ml, e.g. in the range of 450 to 850 ml or 500 to 700 ml.

The tank may have an access opening that is covered by a removable lid, e.g. via a seal. The access opening may be uncovered or free of any lid. Examples of removable lids and/or seals are disclosed in WO 2008/142154 and in PCT/EP 19/057844.

The removable lid can extend over a rim of the tank and have a peripheral wall that extends downwardly to form an outside lid face. The outside lid face may have a height in the range of 0.5 to 5 cm e.g. in the range of 1.5 to 3.5 cm. The outside lid face may extend flush with an outside face of the container uncovered by the lid and/or with an outside face of the base.

The removable lid can have an upright inner wall that extends downwardly into the cavity along a or the above mentioned rim of the tank. For instance, the peripheral wall and/or the upright inner wall has a sealing member, such as an annular deformable sealing member e.g. the above mentioned seal, for sealing off the cavity of the tank. Such sealing member may include at least one of the following features: the sealing member has one or more substantially parallel sealing lips, such as annular lips arranged side-by-side; the sealing member has a tab for seizing the sealing member; and the sealing member is removable from the lid, for instance for cleaning, and mountable on the lid.

The tank can be substantially cup-shaped or bowl-shaped or cylinder-shaped, the sidewall being substantially upright and the bottom wall being substantially flat or curved.

The tank may be mechanically passive. Hence, beyond the inherent mechanical properties of the materials making its structure for containing the food substance and for being integrated or assembled in the machine, the tank may be free of any mechanically active part such as a motor or movement transformation system which may require special care for hygiene or cleaning purposes.

The machine has a stirring tool in the cavity. The tool has a stirring surface for imparting a mechanical effect on the food substance in the cavity to froth the food substance, e.g. a stirring tool driven from outside the tank. The stirring tool may be a passive tool.

For instance, the stirring surface is formed by a helicoidal spring and/or an undulated plate and/or a plurality of radial frothing wings.

The machine has an actuator configured to rotate the stirring tool in the cavity. For instance, the actuator is magnetically coupled to the stirring tool, e.g. via a tank side wall and/or a bottom wall and/or top wall.

The machine includes a control unit configured to control the actuator so that the rotational speed of the stirring tool is changeable.

For instance, the control unit comprises a processor and/or a controller and/or a user-interface, e.g. a user-interface at an outside housing.

The stirring tool may have an upright extending elongated part. For instance, such part is topped with a radial protruding element, such as a ball.

The stirring tool can have an upright arched part such as an arched part located above stirring surface. For instance, the upright arched part is located below the upright extending elongated part.

The stirring tool may include a connection part for connection with a connection part of the tank to position the stirring tool in the tank. The connection parts may form a plug and socket arrangement and/or magnetic connecting parts. The connection parts can be configured to position the stirring tool on a central upright axis in the cavity or in parallel to such axis.

The cavity and the stirring tool may be configured for (central) symmetric processing of the liquid food substance or for asymmetric processing. For instance, a flow perturbator is used to promote homogeneisation of the food substance during processing, e.g. by setting the stirring tool off-set relative to a central upright axis and/or by arranging obstacles in the cavity that interfere with a flow of the food substance during processing.

The stirring tool and its integration into the machine may be of the type disclosed in WO 2006/050900, WO 2008/142154, WO 2016/202814, WO 2016/202815, WO 2016/202816, WO 2016/202817, WO 2018/108804 and WO 2018/108807.

The tank may be electrically passive. Hence, beyond the inherent electrical properties (e.g. resistive and/or inductive and/or capacitive properties) of the materials making its structure for containing the food substance and for being integratable or assembled in the machine, the tank may be free of any electric components, in particular active electric components. The inherent electrical properties of the tank may however be used in the processing of the food substance, for instance for heating and/or cooling the tank that is powered electrically or electromagnetically from an (active) source that is external to the tank.

The control unit has a mode in which the actuator is controlled by the control unit so that:
during a first phase of processing the batch, the stirring tool is rotated below a low frothing rotational speed; and thereafter
during a second phase of processing the batch, the rotational speed of the stirring tool is increased from the low frothing rotational speed to above a high frothing rotational speed; and thereafter
during a third phase of processing said batch, the stirring tool is rotated above the high frothing rotational speed.

At the beginning of the frothing process, the stirring tool can thus be rotated at a lower speed in the batch of liquid food substance and after a while the stirring tool may be rotated a higher speed in the batch of liquid food substance. Thus, when the batch of liquid food substance is in its initial liquid state, the stirring surface, moving at lower speed, is less likely to chase the liquid away and/or less likely to cause an elevation of the liquid food substance to an undesired level in the cavity or beyond the cavity. Thereafter, once the liquid food substance is already partly frothed and the batch of liquid food substance is less fluid and/or more voluminous (e.g. due to partial frothing), it is also less likely to be chased away from the stirring surface moving at higher speed. It follows that adjusting the speed of the stirring tool to take into account the degree of fluidity and/or volume of the batch of liquid food substance during frothing is likely to improve the energy transmission from the stirring surface to the batch (by reducing the effect of chasing the batch away from the stirring surface) and to adjust the exposure of the liquid food substance to air close to the whisk at the beginning of the processing. Thereafter, the thus partly frothed liquid food substance can benefit from the higher speed. Therefore, the required processing time to obtain a desired quality of the frothed liquid substance is likely to be reduced. This beneficial effect is all the more useful when the batch of liquid food substance, e.g. milk or milk-based substance, does not undergo a simultaneous heating conditioning that facilitates the frothing of the substance.

The control unit may be configured to control a voltage supply and/or a current supply and/or a frequency of a power supply to the actuator to adjust the frothing rotational speed of the stirring tool.

Further to the actuator and the control unit, the machine may be free of any thermal conditioner or the machine may include a thermal conditioner that is controlled by the control unit to produce substantially no heat in the cavity in the above mentioned mode during the first, second and third phases, such as during a total length of time of imparting a mechanical effect with the stirring tool on the batch in the cavity, such as a total length of time of processing the batch in the cavity. In other words, in the above mentioned mode, no heat at all or substantially no heat may be generated in the cavity. This does not exclude the fact that a small amount of heat may be generated by mechanical friction or inherent electromagnetic effects of components used in the machine for purposes that are not related to heat generation, e.g. a data communication system or an electric actuator (motor). Optionally, the machine has a thermal conditioner that is able to consume heat from the cavity to cool the batch.

In the above mentioned mode, the batch of liquid food substance can be maintained substantially unheated in the cavity or, in some embodiment, even be cooled. Hence, besides the actuator and the control unit, the machine may be devoid of dedicated heat producing device, in particular devoid of any thermal conditioner, or, when present, such thermal conditioner may be operated to not generate heat in this mode.

Example of suitable thermal conditioners are disclosed in WO 2006/050900, WO 2008/142154, WO 2010/023312, WO 2010/023313 and WO 2019/101765.

When the liquid food substance is maintained unheated or even cooled in the cavity, better froth quality can be obtained by processing the liquid food substance with the stirring tool at higher speed. In such a context, the invention can be advantageously implemented.

The control unit can be configured in the above mentioned mode such that the second phase is engaged after at least one of:
a predetermined period of time corresponding to the first phase, such as a period of time in the range of 10 to 45 sec., such as 15 to 35 sec., e.g. 20 to 25 sec. ; and
a resistance against rotation of the stirring tool has increased while the stirring tool has been rotated below the low frothing rotation speed by at least 10%, such as at least 20%, for instance at least 30%, e.g. at least 40%.

Such resistance can be measured, for instance, by a measure of the torque on the stirring tool or by a measure of the power consumed by the actuator to rotate the stirring tool, e.g. a measure of the current and/or voltage consumed by the actuator.

For instance, when the speed of the stirring tool is controlled by the voltage applied to the actuator, a measure of the current consumed by the actuator at the controlled voltage may be used to indicate the resistance (or its evolution over time) of the liquid food substance against the rotation of the stirring tool.

The control unit may be configured in the above mentioned mode to control the actuator so as to drive during a start-up phase the stirring tool from rest, at a rotational speed of zero, to reach the first phase within a period of time in the range of 2 to 25 sec., such as 5 to 20 sec., e.g. 10 to 15 sec. The stirring tool may be driven during the start-up phase at a rotational speed that is increased from zero to above the low frothing rotational speed to then drop to below the low frothing rotational speed, such as: to less than 15%, e.g. less than 10%, above the low frothing rotational speed; and/or for a period of time above the low frothing rotational speed of less than 10 sec., e.g. less than 6 sec.

During the second phase in the above mentioned mode, the rotational speed of the stirring tool may be increased from the low rotational speed to reach the third phase within a period of time in the range of 5 to 30 sec., such as 10 to 20 sec., e.g. 12 to 16 sec. The stirring tool may be driven during the second phase at a rotational speed that is increased from the low frothing rotational speed to above the high rotational speed to then drop towards the high rotational speed, such as: increased to less than 10%, e.g. less than 5%, above the high rotational speed; and/or for a period of time above the low frothing rotational speed of less than 10 sec., e.g. less than 6 sec.

During the first phase in the above mentioned mode, the rotational speed can be maintained within a span of 3 or 5% of the low rotational speed immediately below the low rotational speed.

During the third phase in the above mentioned mode, the rotational speed may be maintained within a span of 2 to 4% of the high rotational speed immediately above the high rotational speed.

In the above mentioned mode, the first and third phases may last for a cumulated period of time that is in the range of: 45 to 90 sec., such as 50 to 80 sec., for instance 55 to 70 sec., e.g. 60 to 65 sec. ; and/or 50 to 95%, such as 55 to 80%, for instance 60 to 70%, of a total length of time of imparting a mechanical effect with the stirring tool on the batch in the cavity, such as a total length of time of processing the batch in the cavity.

In the above mentioned mode, a or the above mentioned total length of time of imparting a mechanical effect with the stirring tool on the batch in the cavity may be in the range of 60 to 120 sec., such as 70 to 110 sec., for instance 80 to 100 sec., e.g. 85 to 95 sec.

The high rotational speed and the low rotational speed may have a ratio that is in the range of 1.02 to 5, such as 1.05 to 2.5, for instance 1.1 to 1.7, e.g. 1.13 to 1.2.

The low rotational speed can be in the range of 10 to 50 Hz, such as 15 to 40 Hz, for instance 20 to 35 Hz, e.g. 25 to 30 Hz.

The high rotational speed may be in the range of in the range of 15 to 75 Hz, for instance 20 to 65 Hz, such as 25 to 50 Hz, e.g. 30 to 35 Hz.

The control unit can have a different mode in which the actuator is controlled by the control unit so that:
during an initial phase of processing the batch of liquid food substance, for instance an initial phase lasting a period of time in the range of 0.5 to 15 sec. such as 2 to 12 sec. e.g. 4 to 9 sec., the stirring tool being rotated from zero to a constant frothing rotational speed; and thereafter
during a main phase of processing such batch, for instance a main phase lasting a period of time in the range of 50 to 250 sec. such as 75 to 175 sec. e.g. 100 to 140 sec, the rotational speed of the stirring tool is maintained substantially at the constant rotational speed, e.g. at the constant rotational speed or within a range of less than 5% such as less than 2% of the constant rotational speed above and/or below the constant rotational speed, optionally the constant rotational speed being substantially equal to the low rotational speed or in the range of 10 to 50 Hz such as 15 to 40 Hz, for instance 20 to 35 Hz, e.g. 25 to 30 Hz; and thereafter
during an end phase of processing said batch, for instance an end phase lasting a period of time in the range of 0.5 to 10 sec. such as 1.5 to 7.5 sec. e.g. 3 to 5 sec., the rotational speed of the stirring tool being allowed to drop to zero.

The tank may be associated with a thermal conditioner controlled by the control unit that, in this different mode, controls the thermal conditioner to generate heat in the cavity so as to heat said batch, e.g. to a temperature in the range of 55 to 70° C. e.g. 60 to 65° C.

Further modes with different speed profiles of the stirring tool (and optionally corresponding thermal conditioning profiles, e.g. heating and/or cooling) may be provided, as for example known from the prior art, to process the liquid food substance in the cavity.

The machine may include a base supporting the tank.

The base may contain the actuator and the control unit and optionally a or the abovementioned thermal conditioner. Such thermal conditioner may be associated with a tank side wall and/or a bottom wall configured to emit thermal energy into and/or absorb thermal energy from the cavity. The thermal conditioner may incorporate at least one of a resistor e.g. a thick film resistor, an induction, a thermocouple and a heat pump.

Actuators e.g. motors, control units, user-interfaces, AC/DC converters can all be comprised in the base.

The tank may be fixed or integral with the base, or separable from the base by the user, e.g. for cleaning or servicing.

By providing a tank which is mechanically and/or electrically passive (optionally with a lid that is equally passive), it can easily be cleaned, e.g. in a dishwater, without any risk of damaging electric and/or mechanic components, if the tank is separable from the base.

The same result can be achieved when the tank is inseparable (by the user) from the base that is provided with a control cavity, e.g. containing mechanical and/or electric control active constituents, such as actuators and signal processing units, which control cavity has no movable access panel sealed off by a rubber, silicone or like seal that is exposed to early wear, especially when exposed to detergents or soaps used for cleaning. Hence, the same result may be achieved, if the base contains active components that are contained in an inaccessible confinement control cavity, the base being for instance entirely moulded and/or welded around such a confinement cavity so that the cavity is completely sunk in the base's structure and separate from the environment outside the base with no access from the outside without destroying the base. In such circumstances, the base may contain in such confined inaccessible cavity an active device, e.g. an RFID-type device or the like, and still be suitable for cleaning in a dishwasher.

The base can have an upright outside gripping surface, e.g. a textured or striated or corrugated or undulated or ruled or even surface to facilitate hand gripping, located under the tank and seizable by an adult human hand such that the base with the supported tank can be carried and displaced single-handed by seizure of the upright outside gripping surface.

When such a base is provided with an outside gripping surface extending horizontally around at least a substantial part of the base, the machine does not need to be fitted with an elongated handle protruding from an outside face, for instance of the variety disclosed in WO 2006/050900 or in PCT/EP19/057841.

The tank may extend horizontally beyond the outside gripping surface.

By allowing the tank to extend beyond the outside gripping surface, the volume of the tank's cavity may be correspondingly increased in a lateral fashion without affecting the ability of the gripping surface to be gripped by the adult human hand, i.e. the gripping surface is not increased with the tank's cavity volume as in prior art designs. Such a configuration permits the processing of an increased volume of liquid food substance, laterally rather than in elevation, which is advantageous for instance when air is to be incorporated into the liquid food substance during processing (e.g. to froth the liquid food substance).

Such lateral extension of the tank beyond the outside gripping surface of the base may also serve as a support surface on the gripping human hand to improve seizure of the machine single handed.

The outside gripping surface may be at least substantially vertical, for instance vertical or inclined thereto by an angle of less than 15 deg., for instance less than 10 deg., such as less than 5 deg., e.g. less than 2.5 deg.

The tank can have an outer horizontal tank perimeter.

The tank may extend horizontally beyond the outside gripping surface over a predominant part of its tank perimeter, e.g. over more than 50 or more than 75% of its perimeter, such as over substantially the entire perimeter, e.g. above 90 or 95% of the perimeter.

The perimeter may have a circumference in the range of 15 to 70 cm, for instance 20 to 60 cm, such as 25 to 50 cm, e.g. 30 to 40 cm.

The tank can have an upright outer tank surface and the cavity can have a height. The outer horizontal perimeter can extend along the outer tank surface. The outer tank surface can be located horizontally beyond the outside gripping surface over substantially its entire tank perimeter over substantially the entire cavity height. The upright outer tank surface may be located horizontally beyond the outside gripping surface by a distance in the range of 0.5 to 10 cm, for instance 1 to 7 cm, such as 1.5 to 5 cm, e.g. 2 to 4 cm.

The upright outer tank surface may be at least substantially vertical, for instance vertical or inclined thereto by an angle of less than 15 deg., such as less than 10 deg., e.g. less than 5 deg., for example less than 2.5 deg.

The machine may include an outside housing that forms the upright outside gripping surface, the outside housing extending upright along at least part of the outer tank surface. The housing may have a substantially horizontal and/or inclined intermediate portion, e.g. a straight or curved portion, extending from a top of the upright outside gripping surface to a bottom of the upright outer tank surface. The inclined intermediate portion may have an inclination to a horizontal direction in the range of 15 to 75 deg., such as 20 to 70 deg., e.g. 40 to 60 deg.

The machine can include a foot that has a bottom side configured to be placed on a substantially horizontal external support surface, such as a surface formed by a table or a shelf, during processing of the batch of liquid food substance, and to support the base during such processing. For instance, the foot is assembled to or fixed to or integral with the base.

The base may be removably mounted to the foot. The base and the foot can have a connection.

The connection may be configured to inhibit or prevent relative pivoting of the base and the foot about an axis extending along the external support surface during such processing. For instance, the connection is mechanical and/or magnetic.

The connection can be configured to conduct electric power from the foot into the base. For instance, the foot is an electric cord for connection to an external power supply, such as to the mains.

The connection may be configured to be connectable in a plug and socket fashion. For instance, the connection may have a plug part of the foot and a socket part of the base or vice versa.

The foot may extend horizontally beyond the outside gripping surface, e.g. the foot extending horizontally up to or beyond the tank. For instance, the foot extends horizontally beyond the outside gripping surface by a distance in the range of 0.5 to 15 cm, for instance 1 to 10 cm, such as 1.5 to 7 cm, e.g. 2 to 3 cm.

Providing a large foot, e.g. larger than the gripping surface, may increase the stability of the machine during processing on the external processing surface.

The upright outside gripping surface can have a height along which the surface is seizable by the human hand for carrying and supporting single-handed the base and the tank. This height may be of at least 3 cm, for instance in the range of 4 to 20 cm, such as 5 to 16 cm, e.g. 6 to 12 cm.

The cavity can have a volume that is greater than 200 ml, for instance in the range of 250 to 1250, such as in the range 300 to 1000 ml, e.g. in the range of 450 to 850 ml or 500 to 700 ml.

The cavity or an upright part of the stirring tool may be associated with or may comprise an indication arrangement for assisting an appropriate filling of the cavity with liquid food substance to form the batch prior to its processing in the cavity. For instance, the indication arrangement has an indicator, e.g. a high indicator, for a maximum level for thermally conditioning the batch of liquid food substance without frothing and/or an indicator, e.g. a low indicator, for a maximum level for frothing the batch of liquid food substance with or without thermal conditioning. The indicator may include at least one of a verbal sign, a sign e.g. a pictogram of a corresponding stirring tool and a level sign.

The stirring tool may include a homogenising device for homogenizing the batch of liquid food substance during thermal conditioning thereof, such as a homogenising device having at least one radial homogenising arm, e.g. 2, 3 or 4 such arms.

The machine may have a or the above mentioned central upright axis along which at least one of the tank, the cavity, and when present the base and/or the foot, extends. For instance, at least one of the tank, the cavity and, when present, the base and/or the foot has a shape of revolution about the central upright axis, such as a cylindrical and/or conical shape and/or spherical shape.

Examples of such shapes are disclosed in WO 2008/142154 and PCT/EP19/060854.

When reference is made in the present description to an orientation or position relative to the machine or parts thereof, e.g. “above” or “below” or “vertical” or “horizontal”, the orientation or position takes as a reference the position and orientation of the machine in operation to process the liquid food substance in the tank unless specified otherwise.

### BRIEF DESCRIPTION OF THE DRAWINGS

The invention will now be described with reference to the schematic drawings, wherein:

FIG. 1 is a perspective side view of a machine having a tank on a base and foot, a stirring tool, an actuator and control unit configured according to the invention;

FIG. 2 is a perspective side view of the machine of FIG. 1 in which the tank and the base have been separated from the foot;

FIG. 3 is a cross-sectional perspective view of the machine shown in FIG. 1;

FIG. 4 is a graph showing the control of the actuator and the rotational speed of the stirring tool over time in an advantageous mode of the control unit of the machine of FIG. 1; and

FIG. 5 is a graph showing the control of the actuator and the rotational speed of the stirring tool over time in a different mode of the control unit of the machine of FIG. 1.

### DETAILED DESCRIPTION

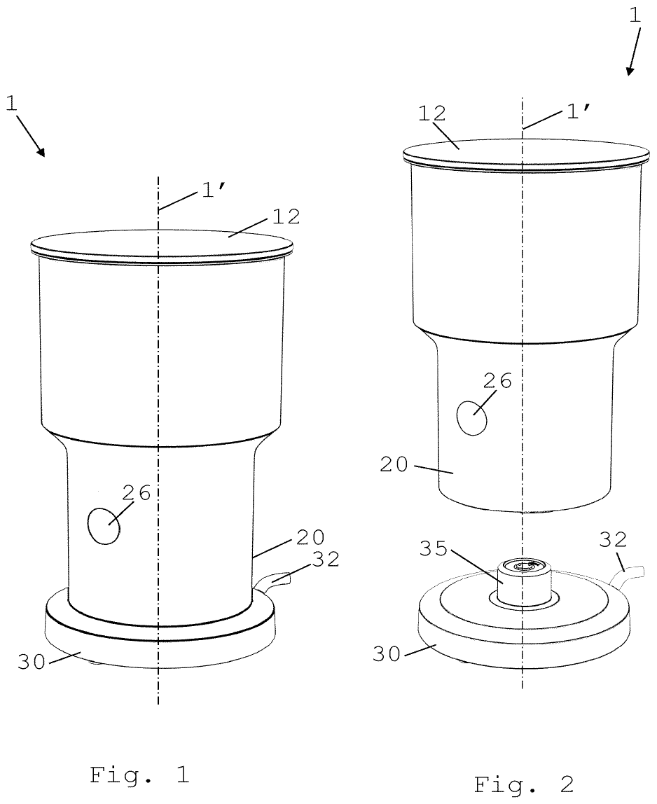

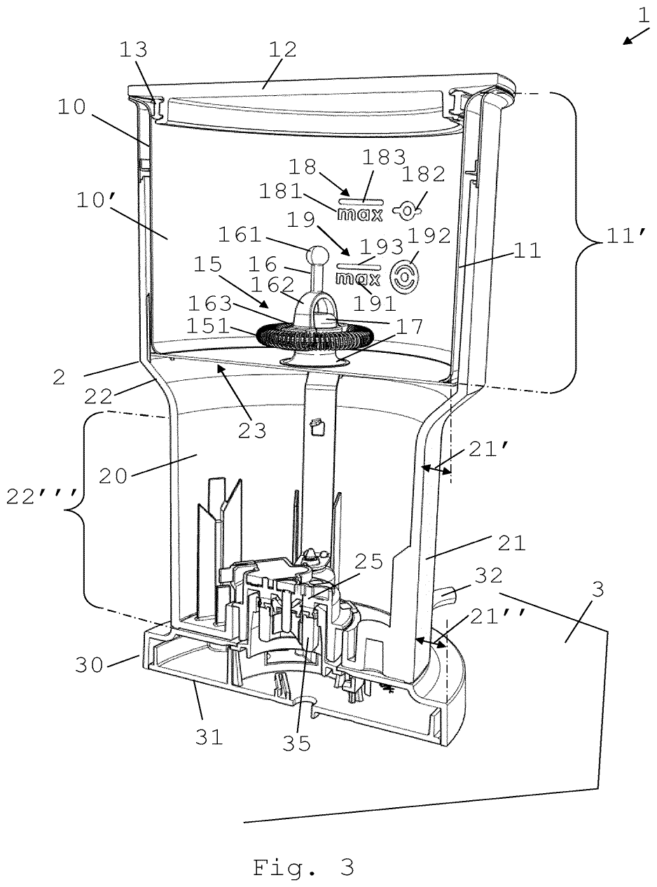

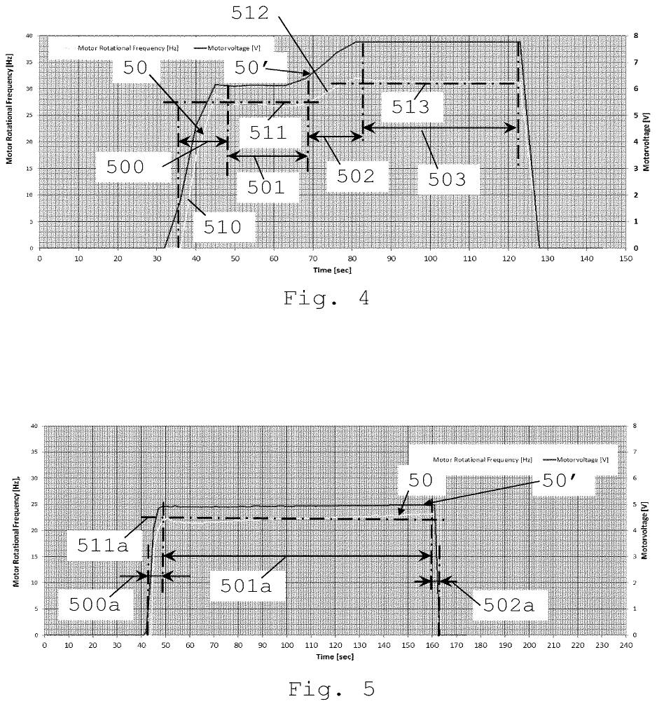

An exemplary embodiment of a machine 1 according to the invention is illustrated in FIGS. 1 to 3. FIGS. 4 and 5 illustrate two possible modes of the machine's control unit to operate the machine's stirring tool.

Machine 1 has a tank 10 with a cavity 10′ for containing and processing a batch of liquid food substance, such as milk or a milk-based substance. Tank 10 may have an access opening that is covered by a removable lid 12, e.g. via a seal 13.

Machine 1 has a stirring tool 15 in cavity 10′. Tool 15 has a stirring surface 151 for imparting a mechanical effect on the food substance in cavity 10′ to froth the food substance. Stirring tool 15 may be driven from outside the tank 10. Stirring surface 151 can be formed by a helicoidal spring and/or an undulated plate and/or a plurality of radial frothing wings.

Machine 1 includes an actuator configured to rotate stirring tool 15 in cavity 10′. The actuator may be magnetically coupled to stirring tool 15, e.g. via a tank side wall and/or a bottom wall and/or top wall.

Machine 1 has a control unit configured to control the actuator so that the rotational speed of stirring tool 15 is changeable. For instance, the control unit includes a processor and/or a controller and/or a user-interface 26, e.g. a user-interface 26 at an outside housing 2.

Stirring tool 15 may have an upright extending elongated part 16. Part 16 may be topped with a radial protruding element 161 such as a ball.

Stirring tool 15 can have an upright arched part 162, such as an arched part, located above stirring surface 151. For instance, upright arched part 162 is located below upright extending elongated part 16.

Stirring tool 15 may have a connection part 163 for connection with a connection part 17 of tank 10 to position stirring tool 15 in tank 10. Connection parts 163,17 may form a plug and socket arrangement and/or magnetic connecting parts. Connection parts 163,17 may be configured to position stirring tool 15 on a central upright axis 1′ in cavity 10′ or in parallel to axis 1′.

The control unit has a mode in which the actuator is controlled by the control unit so that:
during a first phase 501 of processing the batch, stirring tool 15 is rotated below a low frothing rotational speed 511; and thereafter
during a second phase 502 of processing the batch, rotational speed 512 of stirring tool 15 is increased from the low frothing rotational speed 511 to above a high frothing rotational speed 513; and thereafter
during a third phase 503 of processing the batch, stirring tool 15 is rotated above the high frothing rotational speed 513.

The control unit can be configured to control a voltage supply 50′ and/or a current supply and/or a frequency of a power supply to the actuator to adjust the frothing rotational speed 50 of stirring tool 15.

Further to the control unit and to the actuator, such machine 1 may be free of any thermal conditioner or may comprise a thermal conditioner 23 that is controlled by the control unit to produce substantially no heat in cavity 10′ in the above mentioned mode during first, second and third phases 501,502,503, such as during a total length of time of imparting a mechanical effect with stirring tool 15 on the batch in cavity 10′, such as a total length of time of processing the batch in cavity 10′.

The control unit may be configured in the above mentioned mode such that second phase 502 is engaged after at least one of: a predetermined period of time corresponding to the first phase 501, such as a period of time in the range of 10 to 45 sec., such as 15 to 35 sec., e.g. 20 to 25 sec.; and a resistance against rotation of stirring tool 15 has increased while stirring tool 15 has been rotated below the low frothing rotation speed 511 by at least 10%, such as at least 20%, for instance at least 30%, e.g. at least 40%.

The control unit is configured in the above mentioned mode to control the actuator so as to drive during a start-up phase 500 stirring tool 15 from rest, at a rotational speed 50 of zero, to reach first phase 501 within a period of time in the range of 2 to 25 sec., such as 5 to 20 sec, e.g. 10 to 15 sec. Stirring tool 15 may be driven during start-up phase 500 at a rotational speed 510 that is increased from zero to above the low frothing rotational speed 511 to then drop to below the low frothing rotational speed 511, such as: to less than 15%, e.g. less than 10%, above the low frothing rotational speed 511; and/or for a period of time above the low frothing rotational speed 511 of less than 10 sec., e.g. less than 6 sec.

During the second phase 502, rotational speed 50 of stirring tool 15 is increased from low rotational speed 511 to reach third phase 503 within a period of time in the range of 5 to 30 sec., such as 10 to 20 sec, e.g. 12 to 16 sec. Stirring tool 15 may be driven during second phase 502 at a rotational speed 512 that is increased from the low frothing rotational speed 511 to above the high rotational speed 513 to then drop towards high rotational speed 513, such as: increased to less than 10%, e.g. less than 5%, above high rotational speed 513; and/or for a period of time above the low frothing rotational speed 511 of less than 10 sec., e.g. less than 6 sec.

During first phase 501, rotational speed 50 can be maintained within a span of 3 or 5% of low rotational speed 511 immediately below low rotational speed 511.

During third phase 503, rotational speed can be maintained within a span of 2 to 4% of high rotational speed 513 immediately above high rotational speed 513.

First and third phases 501,503 may last for a cumulated period of time that is in the range of: 45 to 90 sec., such as 50 to 80 sec., for instance 55 to 70 sec., e.g. 60 to 65 sec.; and/or 50 to 95%, such as 55 to 80%, for instance 60 to 70%, of a total length of time of imparting a mechanical effect with stirring tool 15 on the batch in cavity 10′, such as a total length of time of processing the batch in cavity 10′.

A or the above mentioned total length of time of imparting a mechanical effect with stirring tool 15 on the batch in cavity 10′ can be in the range of 60 to 120 sec., such as 70 to 110 sec., for instance 80 to 100 sec., e.g. 85 to 95 sec.

High rotational speed 513 and low rotational speed 511 may have a ratio that is in the range of 1.02 to 5, such as 1.05 to 2.5, for instance 1.1 to 1.7, e.g. 1.13 to 1.2.

Low rotational speed 511 may be in the range of 10 to 50 Hz, such as 15 to 40 Hz, for instance 20 to 35 Hz, e.g. 25 to 30 Hz.

High rotational speed 513 can be in the range of 15 to 75 Hz, for instance 20 to 65 Hz, such as 25 to 50 Hz, e.g. 30 to 35 Hz.

The control unit can have a different mode in which the actuator is controlled by the control unit so that:
during an initial phase 500a of processing the batch, for instance an initial phase 500a lasting a period of time in the range of 0.5 to 15 sec. such as 2 to 12 sec. e.g. 4 to 9 sec., stirring tool 15 is rotated from zero to a constant frothing rotational speed 511a; and thereafter
during a main phase 501a of processing the batch, for instance a main phase 501a lasting a period of time in the range of 50 to 250 sec. such as 75 to 175 sec. e.g. 100 to 140 sec, rotational speed 50 of stirring tool 15 is maintained substantially at constant rotational speed 511a, e.g. at constant rotational speed 511a or within a range of less than 5% such as less than 2% of constant rotational speed 511a above and/or below constant rotational speed 511a, optionally constant rotational speed 511a being substantially equal to low rotational speed 511 or in the range of 10 to 50 Hz such as 15 to 40 Hz, for instance 20 to 35 Hz, e.g. 25 to 30 Hz; and thereafter
during an end phase 502a of processing the batch, for instance an end phase 500a lasting a period of time in the range of 0.5 to 10 sec. such as 1.5 to 7.5 sec. e.g. 3 to 5 sec., rotational speed 50 of stirring tool 15 is allowed to drop to zero.

Tank 10 may be associated with a thermal conditioner 23 controlled by the control unit that, in such different mode, controls thermal conditioner 23 to generate heat in cavity 10′ so as to heat the batch of liquid food substance such as milk or a milk-based substance, e.g. to a temperature in the range of 55 to 70° C. e.g. 60 to 65° C.

Machine 1 may include a base 20 supporting tank 10. Base 10 may contain the actuator and the control unit and optionally a or the above mentioned thermal conditioner 23. Thermal conditioner 23 may be associated with a tank side wall and/or a bottom wall configured to emit thermal energy into and/or absorb thermal energy from cavity 10′. The thermal conditioner may comprise at least one of a resistor e.g. a thick film resistor 23, an induction, a thermocouple and a heat pump.

Base 20 can have an upright outside gripping surface 21, e.g. a textured or striated or corrugated or undulated or ruled or even surface to facilitate hand gripping, located under tank 10 and seizable by an adult human hand such that base 20 with supported tank 10 can be carried and displaced single-handed by seizure of the upright outside gripping surface 21. Tank 10 can extend horizontally beyond outside gripping surface 21. Outside gripping surface 21 may be at least substantially vertical, for instance vertical or inclined thereto by an angle of less than 15 deg., for instance less than 10 deg., such as less than 5 deg., e.g. less than 2.5 deg.

Tank 10 may have an outer horizontal tank perimeter.

Tank 10 can extend horizontally beyond outside gripping surface 21 over a predominant part of its tank perimeter, e.g. over more than 50 or more than 75% of its perimeter, such as over substantially the entire perimeter, e.g. above 90 or 95% of the perimeter.

The perimeter can have a circumference in the range of 15 to 70 cm, for instance 20 to 60 cm, such as 25 to 50 cm, e.g. 30 to 40 cm.

Tank 10 may have an upright outer tank surface 11 and cavity 10′ may have a height 11′. The outer horizontal perimeter may extend along outer tank surface 11. Outer tank surface 11 may be located horizontally beyond outside gripping surface 21 over substantially its entire tank perimeter over substantially the entire cavity height 11′. Upright outer tank surface 11 may be located horizontally beyond outside gripping surface 21 by a distance 21′ in the range of 0.5 to 10 cm, for instance 1 to 7 cm, such as 1.5 to 5 cm, e.g. 2 to 4 cm.

Upright outer tank surface 11 can be at least substantially vertical, for instance vertical or inclined thereto by an angle of less than 15 deg., such as less than 10 deg., e.g. less than 5 deg., for example less than 2.5 deg.

Machine 1 may include an outside housing 2 that forms upright outside gripping surface 21. Outside housing 2 may extend upright along at least part of the outer tank surface 11. Housing 2 can comprise a substantially horizontal and/or inclined intermediate portion 22, e.g. a straight or curved portion, extending from a top of upright outside gripping surface 21 to a bottom of upright outer tank surface 11, such as an inclined intermediate portion 22 having an inclination to a horizontal direction in the range of 15 to 75 deg., such as 20 to 70 deg., e.g. 40 to 60 deg.

Machine 1 can have a foot 30 that has a bottom side 31 configured to be placed on a substantially horizontal external support surface 3, such as a surface 3 formed by a table or a shelf, during processing of the batch of liquid food substance, and to support base 20 during such processing. Foot 30 may be assembled to or fixed to or integral with base 20.

Base 20 may be removably mounted to foot 30. Base 20 and foot 30 can have a connection 25,35.

Connection 25,35 can be configured to inhibit or prevent relative pivoting of base 20 and foot 30 about an axis extending along external support surface 3 during such processing. Connection 25,35 may be mechanical and/or magnetic.

Connection 25,35 may be configured to conduct electric power from foot 30 into base 20. For instance, foot 30 has an electric cord 32 for connection to an external power supply, such as to the mains.

Connection 25,35 can be configured to be connectable in a plug 35 and socket 25 fashion. For instance, connection 25,35 has a plug 35 part of foot 30 and a socket 25 part of base 20 or vice versa.

Foot 30 may extend horizontally beyond outside gripping surface 21, e.g. the foot extending horizontally up to or beyond tank 10. Foot 30 may extend horizontally beyond outside gripping surface 21 by a distance 21″ in the range of 0.5 to 15 cm, for instance 1 to 10 cm, such as 1.5 to 7 cm, e.g. 2 to 3 cm.

Upright outside gripping surface 21 can have a height 21″′ along which surface 21 is seizable by the human hand for carrying and supporting single-handed base 20 and tank 10, this height being of at least 3 cm, for instance in the range of 4 to 20 cm, such as 5 to 16 cm, e.g. 6 to 12 cm.

Cavity 10′ can have a volume that is greater than 200 ml, for instance in the range of 250 to 1250, such as in the range 300 to 1000 ml, e.g. in the range of 450 to 850 ml or 500 to 700 ml.

Cavity 10′ or an upright part 16 of stirring tool 15 may be associated with or comprise an indication arrangement 18,19 for assisting an appropriate filling of cavity 10′ with liquid food substance to form the batch prior to its processing in cavity 10′. For instance, the indication arrangement has an indicator 18, e.g. a high indicator 18, for a maximum level for thermally conditioning the batch without frothing and/or an indicator 19, e.g. a low indicator 19, for a maximum level of liquid food substance with or without thermal conditioning. The indicator may include at least one of a verbal sign 181,191, a sign e.g. a pictogram 182,192 of a corresponding stirring tool and a level sign 183,193.

Stirring tool 15 may have a homogenising device 182 for homogenizing the batch of liquid food substance during thermal conditioning thereof, such as a homogenising device with at least one radial homogenising arm, e.g. 2, 3 or 4 radial homogenising arms.

Machine 1 can have a or the above mentioned central upright axis 1′ along which at least one of tank 10, cavity 10′, and when present base 20 and/or foot 30, extends. At least one of tank 10, cavity 10′ and, when present, base 20 and/or foot 30 can have a shape of revolution about central upright axis 1′ such as a cylindrical and/or conical shape and/or spherical shape.

1-15. (canceled)

16. A method of optimizing a frothing of milk or a milk-containing substance, the method comprising:
providing a machine comprising:
a tank having a cavity for containing and processing a batch of liquid food substance;
a stirring tool in the cavity having a stirring surface for imparting a mechanical effect on the food substance in the cavity to froth the food substance;
an actuator configured to rotate the stirring tool in the cavity; and
a control unit configured to control the actuator so that the rotational speed of the stirring tool is changeable;
rotating, by the actuator, the stirring tool below a low frothing rotational speed during a first phase of processing the batch;
increasing, by the actuator, the low frothing rotational speed to a high frothing rotational speed during a second phase of processing the batch; and
rotating, by the actuator, the stirring tool above the high frothing rotational speed during a third phase of processing the batch.

17. The method of claim 16, wherein the second phase is engaged after at least one of:
a predetermined period of time corresponding to the first phase; and
a resistance against rotation of the stirring tool has increased while the stirring tool has been rotated below the low frothing rotation speed by at least 10%.

18. The method of claim 17, wherein the second phase is engaged after the resistance against rotation of the stirring tool has increased while the stirring tool has been rotated below the low frothing rotation speed by at least 20%.

19. The method of claim 17, wherein the second phase is engaged after the resistance against rotation of the stirring tool has increased while the stirring tool has been rotated below the low frothing rotation speed by at least 10%, and further comprising measuring the resistance by measuring a torque on the stirring tool or a power consumed by the actuator to rotate the stirring tool.

20. The method of claim 19, wherein measuring the resistance of the liquid food substance against the rotation of the stirring tool comprises measuring a current consumed by the actuator at a controlled voltage.

21. The method of claim 16, further comprising controlling a voltage supply, a current supply, and/or a frequency of a power supply to the actuator to adjust a frothing rotational speed of the stirring tool.

22. The method of claim 16, wherein the machine comprises a thermal conditioner, and wherein the method further comprises controlling the thermal conditioner to produce substantially no heat in the cavity during the first, second, and third phases.

23. The method of claim 16, further comprising controlling the stirring tool from rest to the low frothing rotational speed within a period of time in the range of 2 to 25 sec.

24. The method of claim 16, further comprising controlling the stirring tool from rest to above the low frothing rotational speed and then drop to below the low frothing rotational speed during a start-up phase.

25. The method of claim 24, wherein, during the start-up phase, the stirring tool is at least one of:
increased to less than 15% above the low frothing rotational speed; and/or
above the low frothing rotational speed for a period of time of less than 10 sec.

26. The method of claim 16, further comprising controlling the stirring tool from the low frothing rotational speed to the high frothing rotational speed during the second phase within a period of time in the range of 5 to 30 sec.

27. The method of claim 16, further comprising controlling the stirring tool from the low frothing rotational speed to above the high frothing rotational speed and then drop to below the high frothing rotational speed during the second phase.

28. The method of claim 27, wherein, during the second phase, the stirring tool is at least one of:
increased to less than 10% above the high frothing rotational speed; and/or
above the high frothing rotational speed for a period of time of less than 10 sec.

29. The method of claim 16, wherein:
during the first phase, the rotational speed is maintained within a span of 3 or 5% of the low rotational speed immediately below the low rotational speed;
during the third phase the rotational speed is maintained within a span of 2 to 4% of the high rotational speed immediately above the high rotational speed; or
the first and third phases lasting for a cumulated period of time that is in the range of:
45 to 90 sec.;
50 to 95% of a total length of time of imparting a mechanical effect with the stirring tool on the batch in the cavity; or
a total length of time of imparting a mechanical effect with the stirring tool on the batch in the cavity being in the range of 60 to 120 sec.

30. The method of claim 16, wherein the high frothing rotational speed and the low frothing rotational speed have a ratio that is in the range of 1.02 to 5.

31. The method of claim 16, wherein:
the low frothing rotational speed is in the range of 10 to 50 Hz, and/or
the high frothing rotational speed is in the range of 15 to 75 Hz.

32. The method of claim 16, wherein the control unit has a different mode in which the actuator is controlled by the control unit so that:
during an initial phase of processing the batch, the stirring tool is rotated from zero to a constant frothing rotational speed;
during a main phase of processing the batch, the rotational speed of the stirring tool is maintained substantially at the constant rotational speed; and
during an end phase of processing the batch, the rotational speed of the stirring tool is allowed to drop to zero.

33. The method of claim 16, wherein the machine further comprises a base supporting the tank, the base containing the actuator and the control unit.

34. The method of claim 33, wherein the machine comprises a foot that has a bottom side configured to be placed on a substantially horizontal external support surface during processing of the batch of liquid food substance to support the base during the processing.

35. The method of claim 16, wherein the stirring tool comprises a homogenizing device for homogenizing the batch of liquid food substance during thermal conditioning thereof.
